(19) United States
(12) Patent Application Publication
(10) Pub. No.: US 2014/0178278 A1
(43) Pub. Date: Jun. 26, 2014

(54) CO2 CAPTURE VIA AMINE-CO2 PRODUCT PHASE SEPARATION

(71) Applicants: Michael Siskin, Westfield, NJ (US); Patrick L. Hanks, Bridgewater, NJ (US); Pavel Kortunov, Flemington (RU); Robert B. Fedich, Long Valley, NJ (US); Patrick P. McCall, Matawan, NJ (US); Hans Thomann, Bedminster, NJ (US); Daniel Leta, Flemington, NJ (US); Lisa S. Baugh, Ringoes, NJ (US); David C. Calabro, Bridgewater, NJ (US); Harry W. Deckman, Clinton, NJ (US)

(72) Inventors: Michael Siskin, Westfield, NJ (US); Patrick L. Hanks, Bridgewater, NJ (US); Pavel Kortunov, Flemington (RU); Robert B. Fedich, Long Valley, NJ (US); Patrick P. McCall, Matawan, NJ (US); Hans Thomann, Bedminster, NJ (US); Daniel Leta, Flemington, NJ (US); Lisa S. Baugh, Ringoes, NJ (US); David C. Calabro, Bridgewater, NJ (US); Harry W. Deckman, Clinton, NJ (US)

(73) Assignee: EXXONMOBIL RESEARCH AND ENGINEERING COMPANY, Annandale, NJ (US)

(21) Appl. No.: 14/087,377

(22) Filed: Nov. 22, 2013

Related U.S. Application Data
(60) Provisional application No. 61/740,982, filed on Dec. 21, 2012.

(51) Int. Cl. B01D 53/62

(52) U.S. Cl. CPC B01D 53/62
USPC 423/228

(57) ABSTRACT

Systems and methods are provided for performing CO₂ sorption and regeneration processes that can take advantage of phase changes between solutions of amine-CO₂ reaction products and precipitate slurries, where the slurry particles can include solid precipitates formed based on the amine-CO₂ reaction products. An amine solution can be used to capture CO₂ from a gas phase stream. During this initial capture process, the amine-CO₂ reaction product can remain in solution. The solution containing the amine-CO₂ reaction product can then be exposed to a set of conditions which result in precipitation of a portion of the amine-CO₂ reaction product to form a slurry. The precipitate slurry can be passed into one or more release stages where the conditions for the slurry are altered to allow for release of the CO₂.

### CROSS-REFERENCE TO RELAYED APPLICATIONS

This application claims the benefit of U.S. Application Ser. No. 61/740,982, filed on Dec. 21, 2012; which is incorporated by reference herein in its entirety.

### FIELD OF THE INVENTION

This invention relates to the removal of carbon dioxide and other acid gases from a gaseous stream containing one or more of these gases. In particular, the invention relates to a method for separating an acid gas, e.g., carbon dioxide, from a gas mixture using one or more sterically hindered amines as the sorbent.

### BACKGROUND OF THE INVENTION

The removal of carbon dioxide from mixed gas streams is of great industrial importance and commercial value. Carbon dioxide is a ubiquitous and inescapable by-product of the combustion of hydrocarbons and there is growing concern over its accumulation in the atmosphere and its potential role in global climate change. If laws and regulations driven by environmental factors are enacted, capture and sequestration may be required. While existing methods of CO₂ capture have been satisfactory for the scale in Which they have so far been used, future uses on the far larger scale required for significant reductions in atmospheric CO₂ emissions from major stationary combustion sources, such as power stations fired by fossil fuels, makes it necessary to improve the energy efficiency of the processes used for the removal of CO₂ from gas mixtures, and thereby to lower the cost of CO₂ capture. According to data developed by the Intergovernmental Panel on Climate Change, power generation produces approximately 78% of stationary source emissions of CO₂ with other industries such as cement production (7%), refineries (6%), iron and steel manufacture (5%), petrochemicals (3%), oil and gas processing (0.4%), and the biomass industry (bioethanol and bioenergy) (1%) making up the bulk of the total, illustrating the very large differences in scale between power generation on the one hand and all other uses on the other. To this must be added the individual problem of the sheer volumes of gas which will need to be treated. Flue gases generally consist mainly of nitrogen from combustion air, with the CO₂, nitrogen oxides, and other emissions such as sulfur oxides making up relatively smaller proportions of the gases which require treatment. Typically, the wet flue gases from fossil fuel power stations typically contain about 7-15 vol % of CO₂, depending on the fuel, with natural gas yielding the lowest amounts and hard coals the highest.

Cyclic CO₂ sorption technologies such as Pressure Swing Absorption (PSA) and Temperature Swing Absorption (TSA) using liquid sorbents are well-established. The sorbents mostly used include liquid solvents, as in amine scrubbing processes, although solid sorbents are also used in PSA and TSA processes. Liquid amine sorbents dissolved in water are probably the most common sorbents. Amine scrubbing is based on the chemical reaction of CO₂ with amines to generate carbonate/bicarbonate and carbamate salts—the aqueous amine solutions chemically trap the CO₂ by the formation of one or more ammonium salts, such as carbamate, bicarbonate, and carbonate. The reaction tends to be reversible, and these salts can be converted back to the original components upon suitable adjustment of conditions, usually temperature, enabling the regeneration of the free amine at moderately elevated temperatures. Commercially, amine scrubbing typically involves contacting the acid gas (CO₂ and/or H₂S) containing gas stream with an aqueous solution of one or more simple alkanolamines selected preferentially, as the hydroxyl group confers greater solubility in water for both the amine(s) and for the reaction product(s). Alkanolamines, such as monoethanolamine (MEA), diethanolamine (DEA), and triethanolamine (TEA), as well as a limited set of hindered amines, are currently used in commercial processes. The cyclic sorption process requires high rates of gas-liquid heat exchange, the transfer of large liquid inventories between the sorption and regeneration zones, and high energy requirements for the regeneration of amine solutions. The corrosive nature of amine solutions containing the sorbed CO₂, which forms the amine-CO₂ reaction products, can also be an issue. Without further improvement, these difficulties would limit the economic viability of the aqueous amine scrubbing processes in very large scale applications.

The cyclic sorption processes using aqueous sorbents typically require a significant temperature differential in the gas stream between the sorption and desorption (regeneration) parts of the cycle. In conventional aqueous amine scrubbing methods, relatively low temperatures (e.g., less than 50° C.) are required for CO₂ uptake, with an increase to a temperature above about 100° C. (e.g., 120° C.) required for desorption. The heat required to maintain the thermal differential is a major factor in the cost of the process. With the need to regenerate the solution at temperatures above 100° C., the high latent heat of vaporization of the water (˜2260 kJ/Kg at ˜100° C.) obviously makes a significant contribution to the total energy consumption. If CO₂ capture is to be conducted on the larger scale appropriate to use in power plants, more effective and economical separation techniques need to be developed.

Another area where more efficient CO₂ separation processes are needed is in enhanced oil recovery (EOR), where CO₂ is re-injected into the gas or liquid hydrocarbon deposits to maintain reservoir pressure. With the advanced age of many producing reservoirs worldwide and the ever-increasing challenge of meeting demand, the expanding use of EOR methods is becoming more widespread. Typically, the source of carbon dioxide for EOR is the producing hydrocarbon stream itself, which may contain anywhere from less than 5% to more than 80% of CO₂. Other options are capture of CO₂ from the flue gases of various combustion sources and pre-combustion capture of CO₂ from shifted syngas produced in fuel gasification processes.

The use of sterically hindered amities for CO₂ capture was proposed by Sartori and Savage in “Sterically Hindered Amines for CO₂ Removal from Gases,” Ind. Eng. Chem. Fundamen., 1983, 22(2), 239-249, pointing out that sterically hindered amines can have unique capacity and rate advantages in CO₂ sorption processes their rich solutions can be desorbed to a greater extent than their non-substituted and/or less hindered counterparts, thus producing a leaner solution (lower total carbamate/bicarbonate/carbonate concentration), which tends to result in a greater mass transfer upon reabsorption. A limited number of processes using sterically hindered amities as alternatives to MEA, DEA, and TEA are used commercially for CO₂ capture; examples include the KS-1™ Process from Mitsubishi Heavy Industries and Kansai Electric Power Co and the ExxonMobil Flexsorb® Process, which uses sterically hindered amine(s) for selective H₂S separation. Processes using solid sorbents are also known; they may avoid some of the limitations of amine scrubbing, such as large capital investment and high regeneration energy intensity, but they suffer from a lack of sorbents having sufficiently selective CO₂ sorption under the humid conditions present in combustion flue gas and from the difficulty in designing gas/solid contactors to process large volumes of gas at high throughput rates.

U.S. Pat. No. 7,846,240 describes a chilled ammonia based CO₂ capture system. CO₂ is sorbed using an ammonia or ammonium carbonate solution or slurry at a temperature below ambient. If a slurry is used, the particles in the slurry correspond to particles of ammonium carbonate and/or bicarbonate that have precipitated in the solution. When a slurry is used, the carbon capture and release mechanism is based on consumption and generation of CO₂ as the particles in the slurry convert between carbonate and bicarbonate forms. In addition to maintaining the ammonia at a below ambient temperature, increased pressures are also used to prevent loss of ammonia in exhausted flue gas.

### SUMMARY OF THE INVENTION

In an embodiment, a method for separating carbon dioxide from a gas stream is provided. The method can include contacting a gas stream containing CO₂ in a sorption zone with a sorption solution comprising an amine, the sorption solution having a total amine concentration of at least about 2.0 M, at a temperature of at least 10° C. to sorb at least a portion of the CO₂ into the sorption solution and form a rich stream of the sorbed CO₂ in the sorption solution comprising amine-CO₂ reaction products dissolved in the solution; passing the rich stream from the sorption zone to a second zone and precipitating at least a portion of the amine-CO₂ reaction products to form a precipitate slurry; separating the precipitate slurry to form a portion enriched in precipitate solids and a first recycle stream, the first recycle stream comprising a majority of the solvent from the precipitate slurry; and passing the portion enriched in precipitate solids to one or more regeneration zones and desorbing the sorbed CO₂ as gas to form a second recycle stream, the second recycle portion containing a lower concentration of CO₂ than the rich stream and containing an increased concentration of amine relative to the rich stream, wherein the sorption solution comprises at least a portion of the first recycle stream and at least a portion of the second recycle stream.

In another embodiment, a method for separating carbon dioxide from a gas stream is provided. The method can include contacting a gas stream containing CO₂ in a sorption zone with a sorption solution comprising a sterically hindered amine, the sorption solution having a total amine concentration of at least about 2.5 M, at a temperature of at least 10° C. to sorb at least a portion of the CO₂ into the sorption solution and form a rich stream of the sorbed CO₂ in the sorption solution comprising amine-CO₂ reaction products dissolved in the solution; passing the rich stream from the sorption zone to a second zone and precipitating at least a portion of the amine-CO₂ reaction products to form a precipitate slurry; separating the precipitate slurry to form a portion enriched in precipitate solids and a first recycle stream, the first recycle stream comprising a majority of the solvent from the precipitate slurry, preferably at least 80 wt % of the precipitate solids comprising a bicarbonate salt; and passing the portion enriched in precipitate solids to one or more regeneration zones and desorbing the sorbed CO₂ as gas to form a second recycle stream, the second recycle portion containing a lower concentration of CO₂ than the rich stream and containing an increased concentration of sterically hindered amine relative to the rich stream, wherein the sorption solution comprises at least a portion of the first recycle stream and at least a portion of the second recycle stream.

### BRIEF DESCRIPTION OF THE DRAWINGS

FIG. 1 shows a phase diagram for 2-amino-2-methyl propanol (AMP).

FIG. 2 shows a vapor-liquid equilibrium plot for AMP.

FIG. 3 shows ¹³C NMR plots for AMP-CO₂ reactions.

FIG. 4 shows ¹³C NMR plots for MAP-CO₂ reactions.

FIG. 5 shows ¹³C NMR plots for MAMP-CO₂ reactions=2-methylamino-2-methyl propanol).

FIG. 6 shows an example of a processing system suitable for performing an embodiment of the invention.

FIG. 7 shows ¹³C NMR spectra of ˜70 wt % tetramethylguanidine D₂O before and after treatment with CO₂ at ˜90° C.

FIG. 8 shows ¹³C (left) and ¹H (right) NMR spectra of 10 wt % piperazine in d6-DMSO before and after treatment with CO₂ at ˜50° C., ˜70° C., and ˜90° C.

FIG. 9 shows ¹³C NMR spectra of ˜30 wt % ˜1:2 mixture of piperazine with TMG in d6-DMSO before and after treatment with CO₂ at ˜30° C.

FIG. 10 schematically shows a structure of amine-rich PEI molecules before (left) and after (right) reaction with CO₂ forming intramolecular and intermolecular PEI carbamates in non-aqueous solution.

FIG. 11 schematically shows a structure of amine-rich PEI molecules after reaction with CO₂ and TMG forming mixed polar PEI-TMG carbamates in non-aqueous solution.

### DETAILED DESCRIPTION OF THE EMBODIMENTS

### Overview

In various aspects, systems and methods are provided for performing CO₂ capture (sorption) and release (regeneration) processes that can take advantage of phase changes between solutions of amine-CO₂ reaction products (typically some type of amine salt) and precipitate slurries where the slurry particles include solid precipitates formed based on the amine-CO₂ reaction products. An amine solution can be used to capture CO₂ from a gas phase stream. During this initial capture process, the amine-CO₂ reaction product can remain in solution. The solution containing the amine-CO₂ reaction product can then be exposed to a set of conditions which can result in precipitation of a portion of the amine-CO₂ reaction product to form a slurry. This can occur in the capture stage or vessel, or preferably this can occur in a stage or vessel downstream from the capture stage or vessel. The conditions for causing precipitation can include a change in the temperature of the solution, addition of extra CO₂ to the solution, a change in pH for the solution, or a combination thereof. Optionally, a portion of the amines in the amine solution can correspond to promoter amines to facilitate capture of the CO₂ during the capture process. In certain embodiments, the amine solution can include sterically hindered amines that can form a precipitate of amine-CO₂ reaction product(s) under convenient processing reaction conditions.

After capturing CO₂ and forming a precipitate slurry of the amine-CO² reaction product(s), the precipitate slurry can optionally but preferably be passed into one or more release stages where the conditions for the slurry can be altered to allow for release of CO₂. This can also typically result in regeneration of a smaller fraction of the total amine solution, so that the amine solution can be used again in the CO₂ capture stage. It is noted that the release process does not necessarily result in release of all the CO₂, so that the regenerated amine solution may contain at least some amine-CO₂ reaction product before being exposed again to a CO₂-containing gas stream.

In the design of a practical CO₂ capture process, a number of issues can be considered, including the efficiency of the capture process in terms of the cyclic capacity of the process, the efficiency of the capture process in terms of the energy required for desorption of the CO₂ and regeneration of the amine sorbent, the requirement for steady replenishment of fresh amine to maintain the desired sorption capacity, as well as corrosion factors. These issues can, of course, be directly affected by the chemistry and/or the efficiency of the sorption processes. As such, conventional aqueous amine scrubbing processes can be dependent in part on the ability of the sorbent medium to react with the CO₂ and on the rate of that reaction. Another important factor can be the optimum combination of conditions for sorption and desorption of CO₂, which can usually define or limit the cyclic capacity (also known as the swing capacity or working capacity of the amine scrubbing process). The molar ratio of the CO₂ capture per mole of amine can be one factor that can determine the cyclic capacity. Another factor can be the practical concentration of the amine in the solution. More CO₂ per unit of amine can be captured as the concentration of the amine increases, and, in turn, a more concentrated solution of amine per unit volume of solution can confer several benefits. First, less liquid amine solution can be circulated between the sorber and stripper zones as the carrying capacity increases with increasing amine concentration. Second, a more concentrated amine solution can require less energy to regenerate the amine and release the CO₂ in the stripper zone, since less water enters the stripper.

In conventional aqueous amine systems, the process by which CO₂ can be sorbed by tertiary amines is believed to proceed by dissolution of the gaseous CO₂ in water to form carbonic acid (H₂CO₃), which can be neutralized by the amine to form an ammonium bicarbonate. At high pH, the ammonium bicarbonate may then react with a second mole of amine to form an ammonium carbonate. Primary and secondary amines may also react directly with the CO₂ to form an ammonium carbamate, which itself can be stable in the presence of water and may appear as a significant reaction product, especially at high amine concentration; tertiary amines, lacking a free proton, are typically incapable of forming the carbamate, which is believed to be formed by primary and secondary amines by the initial formation of an unstable zwitterion intermediate, which can rapidly decompose via internal proton transfer to the carbamic acid. Both the zwitterion and the carbamic acid can typically be unstable, and it is not known which equilibrium form undergoes further reaction, although it is posited that it can be the carbamic acid, which may be deprotonated by a second equivalent of free amine to produce the ammonium carbamate salt with the overall stoichiometric requirement of two moles of amine per one mole of carbon dioxide sorbed (0.5:1 CO₂:amine).

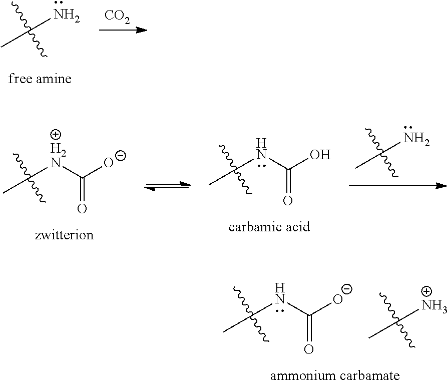

Further reaction of the carbamate with water may lead to a final bicarbonate product with a ˜1:1 CO₂:amine ratio, or to a carbonate product with a ˜0.5:1 CO₂:amine ratio, e.g., depending on solution pH. Thus, the conventional aqueous amine processes, which use primary amines, can have a limited sorption efficiency, which can thus have a maximum CO₂:amine molar of ratio of ˜1:1, achieved with the formation of the bicarbonate as the final reaction product.

While the use of hindered amines for CO₂ removal might therefore present itself as an attractive approach, operational problems and difficulties have been previously encountered. For example, although the sterically hindered primary amine 2-amino-2-methyl-1-propanol (AMP) forms a bicarbonate from which the free amine is readily thermally released, AMP can also form relatively insoluble precipitates at amine concentrations above about 3M in aqueous solution. In a conventional system where it is desirable for the amine-CO₂ products to remain in solution, this has been viewed as a shortcoming, as a solution of AMP has to be relatively dilute in order to satisfy the constraint of avoiding precipitation of the amine-CO₂ products. To meet such a constraint for a solution-only CO₂ capture processes, the physical size of the unit for a given treatment capacity may need to be rather large to handle the higher volume of liquid solvent, resulting in a larger capital investment, a lower operating efficiency, and a higher cost for the CO₂ capture.

In contrast to a conventional system, in various embodiments, formation of a precipitate slurry of the amine-CO₂ reaction product or products can be desirable. Formation of a precipitate slurry can occur under reasonable processing conditions for a variety of amines. Some examples of suitable amines can include sterically hindered amines that form precipitate products under reasonable conditions, such as 2-amino-2-methyl-1-propanol (AMP), and/or 2-methylamino-2-methyl-1-propanol (MAMP). Depending on the nature of the amine, formation of a precipitate slurry can assist in creating a larger working capacity for an amine capture process. Additionally or alternately, formation of a precipitate slurry can assist in reducing processing costs associated with release of CO₂ from the slurry product. For example, in a conventional solution-based capture and release process, both the CO₂ capture and release stages involve passing the entire solution into a stage. Thus, any temperature changes (either heating or cooling) are performed on the entire solution. By contrast, due to formation of a precipitate slurry, a portion of the water (or other solvent) can be removed from the slurry before the CO₂ release stage. As a result, only the remaining portion of the water (solvent) in the slurry may need to be heated during CO₂ release. By reducing or minimizing the amount of amine solution heated and/or chilled, the heat transfer requirements for the capture and release system can be reduced. This can allow for higher circulation rates, as well broadening the range of potential processing conditions that can be selected.

### Gas Stream

Gas streams particularly amenable to treatment by the present sorption processes can include, but are not necessarily limited to, flue gas from the combustion of carbonaceous fuels and natural gas from subterranean sources. Flue gas streams may originate from the combustion of carbon-containing fossil fuels such as natural gas, lignite coals, sub-bituminous coals, bituminous coals, and anthracite coals. Their CO₂ content may typically vary from about 3-15 vol %, depending on the fuel, with the highest levels coming from hard coal combustion and the lowest from natural gas. Natural gas streams containing carbon dioxide may contain, in addition to methane and carbon dioxide, one or more other gases such as ethane, propane, n-butane, isobutane, hydrogen, carbon monoxide, ethane, ethyne, propene, nitrogen, oxygen, helium, carbonyl sulfide, hydrogen sulfide, and the like, as well as, in some cases, mercury or other metal contaminants, if they have not been removed by other pre-treatment. Additional or alternative streams that can be treated by the present separation process can include syngas and shifted syngas produced in fuel gasification processes, gas streams produced in the manufacture of hydrogen, for example from methane steam reforming, and gas streams from refinery and petrochemical plants, whose compositions can naturally depend on the process from which they are derived. Water is typically likely to be present both in flue gases and in natural gas from combustion of hydrocarbon fuels or from contact with ground waters. For embodiments involving a non-aqueous solvent, although the present process can accept water in the entering gas stream, removal of substantial quantities may be desirable when release or regeneration is performed at a temperature below about 100° C. For example, water can be removed by treatment with a drying agent or by cooling to condense water, and thereby to reduce the water content, e.g., so as to avoid an undesirable accumulation of water in an otherwise non-aqueous process.

The pressure of the gas stream can vary according to its origin; natural gas streams can typically be encountered at higher pressures than flue gas streams, and streams from refinery and petrochemical units can vary according to the processing conditions used in the unit. Flue gas streams can typically exhibit roughly atmospheric pressures, which can be as low as ˜0.90 bara (˜90 kPaa) but the partial pressure of the carbon dioxide in the flue gas stream can typically be in the range from about 0.03 bar (about 3 kPa) to about 0A bar (about 10 kPa) or from 0,03 bar (about 3 kPa) to 0,15 bar (about 15 kPa), with relatively large amounts of nitrogen from combustion air typically resulting in relatively low CO₂ partial pressures in the stream (e.g. ˜1 vol % CO₂ in N2 or oxygen-depleted air in the total flue gas at ˜1 bara (˜100 kPaa) can result in a CO₂ partial pressure of ˜0.01 bar (˜1 kPa) in the flue gas; ˜10 vol % CO₂ in N₂ or oxygen-depleted air in the total flue gas at ˜1 bara (˜100 kPaa) can result in a CO₂ partial pressure of ˜0.1 bar (˜10 kPa) in the flue gas; etc.). The partial pressure of the CO₂ in the sorption zone (tower inlet) can typically be at least about 0.025 bar (˜2.5 kPa), and in most cases at least about 0.03 bar (˜3 kPa).

### Amine Sorbents

In various embodiments, the amine sorbents can satisfy two types of criteria. One feature is to have an amine or amines that can readily form precipitates under conditions suitable for use in a solvent/slurry system. This can include an amine or amines that can form precipitates after sorption of CO₂ at a CO₂ partial pressure of about 0.1 bar (˜10 kPa), a temperature of about 25° C. to about 60° C., and an amine concentration high enough to provide a desirable working capacity (such as at least about 2M) but also low enough for the viscosity of the solution to be suitable for flow between vessels. Additionally, the amines can preferably form amine-CO₂ products resulting in a high working capacity between the capture and release stages of the reaction system. A desirable working capacity can often be associated with an amine or amines having a relatively low stability carbamate, so that the carbamate portion of the reaction products can be reduced/minimized relative to the bicarbonate portion.

Preferably, the amities used for CO₂ capture can be sterically hindered amines, such as sterically hindered primary or secondary amines. The sterically hindered amines may advantageously have no more than one proton (hydrogen atom) on the carbon atom alpha to an amino group. Preferably, the amines can correspond to amines with sufficient steric hindrance that the amine does not form a carbamate or forms a carbamate with relatively low stability, such as a carbamate that rapidly decomposes to facilitate bicarbonate formation. This can improve the potential working capacity for the hindered amines by reducing/minimizing the amount of carbamate formed during CO₂ capture. Additionally, by selecting an amine where the insoluble bicarbonate form is the primary (or only) stable salt, precipitation of the amine can be more readily controlled. In particular, when precipitation is induced, all or nearly all of the amine salts in solution (or alternatively all of the amine salts above the solubility limit) can advantageously participate in the solid-liquid equilibrium for precipitation, as opposed to having a portion of the amine salts that are soluble in solution, while another portion is precipitating. Having primarily (or only) a stable bicarbonate form for the amine salts can also be beneficial from a stoichiometry standpoint, as the ratio of amine to sorbed CO₂ can be ˜1:1 for a bicarbonate salt, while the ratio for a carbamate salt can be ˜1:0.5.

Due to their high basicity and steric hindrance on the amino group, sterically hindered amines can allow fine tuning of the types of reaction products and/or precipitates by adjusting conditions (e.g., temperature, pressure, concentration, etc.) of the composition of CO₂-amine reaction products. The formation of carbamate and bicarbonate reaction products can be partly or completely controlled by using selected sterically hindered amines. For example, some types of sterically hindered amines can form a carbamate salt, but the salt may have a short lifetime and can quickly convert to the more desirable bicarbonate salt, according to the following proposed mechanism:

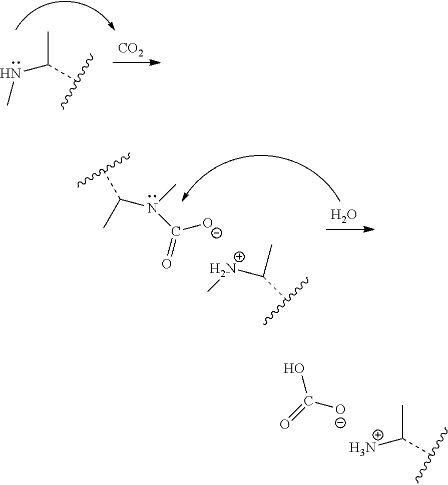

For some types of sterically hindered amines, forming a bicarbonate still via an intermediate carbamate salt can provide a faster reaction pathway than direct formation of the bicarbonate salt. Preferably, for precipitate solids formed based on amine-CO₂ reaction products, amine bicarbonates can correspond to at least 75 wt % of the amine-CO₂ reaction products in the solids, preferably at least about 80 wt % or at least about 90 wt %.

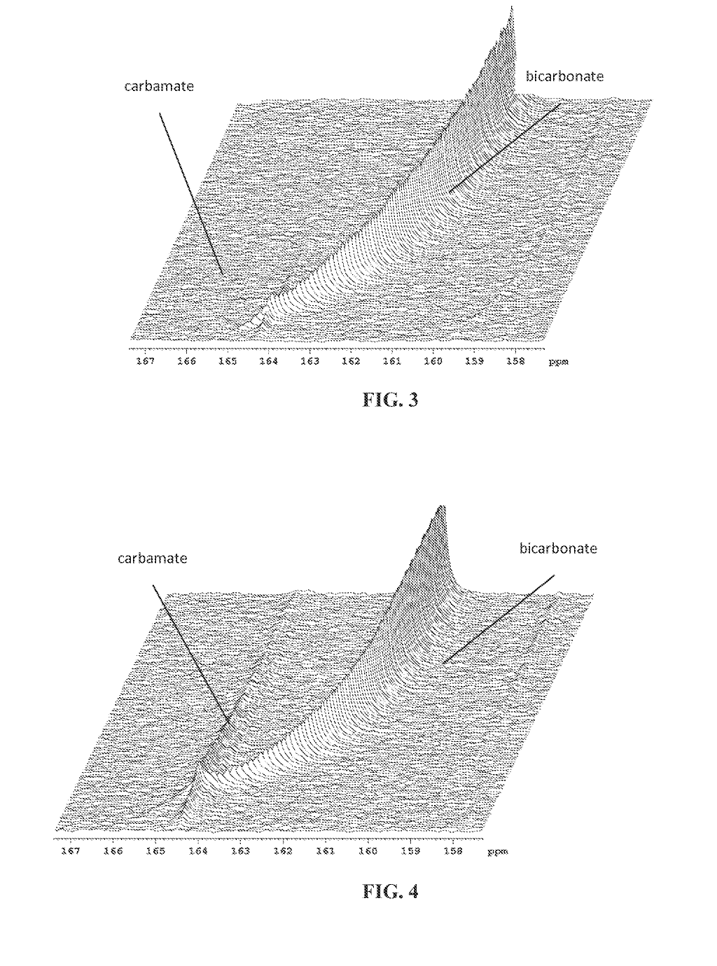

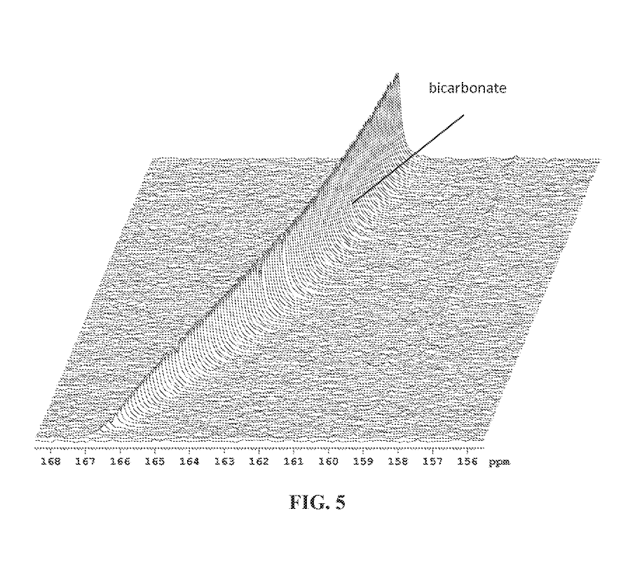

FIG. 3 shows an example of a ¹³C NMR plot at ˜30° C. showing the development of amine-CO₂ reaction products for a sterically hindered amine (AMP) that forms a relatively low stability carbamate. The carbamate is believed to exhibit a relatively low stability due to steric hindrance, which can force and/or accelerate the decomposition of any carbamate formed. The plot in FIG. 3 tracks the changes the development of reaction products over time as CO₂ is passed through a primarily aqueous solution of AMP (˜27 wt %, ˜3M). As shown in FIG. 3, a brief initial concentration of carbamate can be built up, but this carbamate can quickly be converted to bicarbonate. FIG. 4 shows a similar reaction mechanism for the sterically hindered amine 2-N-methylaminopropan-1-ol (MAP; 27 wt %). FIG. 5 shows that 2-N-methylamino-2-methylpropan-3-ol (MAMP) appears to have a different reaction mechanism. In FIG. 5, an initial carbamate concentration was not detected for CO₂ sorption by MAMP (˜31 wt %). Instead, only an increase in bicarbonate concentration was detected. For each of AMP, MAP, and MAMP, the plots in FIGS. 3-5 appear to show that the amine-CO₂ reaction product in solution for suitably sterically hindered amines can be primarily bicarbonate, with little or no carbamate.

Although FIGS. 3-5 show hindered amines either without a carbamate salt or with a low stability carbamate salt, not all sterically hindered amines may have a liquid-solid phase transition at appropriate concentrations for formation of a slurry. Appropriate concentrations can include concentrations where the amine has both a) a solid/liquid phase transition in the presence of between about 0.05 bar (about 5 kPa) and about 1.0 bar (about 300 kPa) of CO₂ and b) a viscosity suitable for flow within a reaction system. For example, an ˜4M solution of AMP in the presence of about 0.1 bar (10 kPa) of CO₂ can start precipitate at around 30° C. Solutions of MAMP can also start to precipitate at appropriate concentrations for operation in a reaction system. For example, an ˜5M solution of MAMP can precipitate at around 30° C. in the presence of about 1.0 bar (about 100 kPa) of CO₂. By contrast, MAP solutions with viscosities suitable for use in a reaction system do not appear to precipitate under typical conditions found in a cyclic capture/release process. Thus, not all sterically hindered amines may be suitable for formation of a slurry. Additionally, sonic tertiary amines and/or other non-hindered amines may be suitable for slurry formation, even if the amines are not sterically hindered. For example, piperazine in a non-aqueous solution and in the presence of between about 0.05 bar (about 5 kPa) and about 1 bar (about 100 kPa) of CO₂ can have phase transitions at piperazine concentrations with a suitable viscosity for good flow within a reaction system.

Some examples of sterically hindered amines suitable for use in a CO₂ separation process can include alkanolamines/aminoethers that can be described by the general formula:

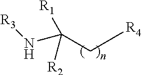

where R₁ is hydrogen or a C₁-C₄ alkyl or hydroxyalkyl group (e.g., —CH₃, —C₂H₅, —CH₂OH, or —C₂H₄OH); R₂ is a C₁-C₄ alkyl or hydroxyalkyl group, (e.g., —CH₃, —C₂H₅, —CH₂OH, or —C₂H₄OH); R₃ is hydrogen or a C₁-C₄ alkyl group, (e.g., CH₃); and R₄ is —OH or —OR₅, where R₅ is —(CH₂)—C(R₁R₂)—NHR₃; and (each) n is an integer from 1 to 4 (e.g., from 1 to 3). In one preferred embodiment, the sterically hindered amine can correspond to a structure where R₁ is —CH₁, R₂ is —CH₃, R₃ is hydrogen or —CH₃, R₄ is —OH, and n is 1. For such a preferred embodiment, if R₃ is hydrogen, the structure corresponds to 2-amino-2-methyl-1-propanol (AMP), while, if R₃ is —CH₃, the structure corresponds to 2-N-methylamino-2-methyl-1-propanol (MAMP). Optionally, the sterically hindered amines can correspond to amines with a molecular weight of about ISO amu or less, such as about 150 amu or less, or about 120 amu or less, or about 100 amu or less.

Another aspect of selecting a suitable sterically hindered amine can involve solution loading, in particular to select an amine that can be loaded to a relatively high concentration in solution while maintaining a low enough viscosity to allow for desirable flow characteristics. For example, an ˜3M solution of AMP (˜27 wt %) in water at around 45° C. can have a viscosity of about 2.5 cP. More generally, in sonic embodiments, the viscosity of an amine solution can be about 15 cP or less, such as about 10 cP or less, about 8 cP or less, about 7 cP or less, or about 5 cP or less.

In various embodiments, the amount of amine in solution can be an amount that provides for a desirable amount of CO₂ sorption while maintaining a desirable viscosity for flow within the reaction system. Preferred concentrations may vary with the particular amine, as the desirable concentration can also depend on the concentration that causes precipitation under favorable conditions. In certain embodiments, the amine concentration can be at least about 1.5M, e.g., at least about 2.0M, at least about 2.5M, at least about 3.0M, at least about 4.0M, or at least about 5.0M. Additionally or alternatively, the amount of amine concentration can be about 9.0M or less, e.g., about 8.0M or less, about 7.0M or less, or about 6.0M or less.

### Precipitation of Amine-CO₂ Reaction Products (Bicarbonates)

One option for improving the working capacity of certain hindered amines can be to take advantage of a phase transition, so that captured CO₂ can be precipitated prior to release or regeneration. In this type of embodiment, CO₂ capture can be performed (at least in part) in a solution phase, while release can be performed in a solid or slurry phase. This can be accomplished by intentionally inducing a phase transition between the solution and slurry phases at a desired location in a CO₂ capture and release system.

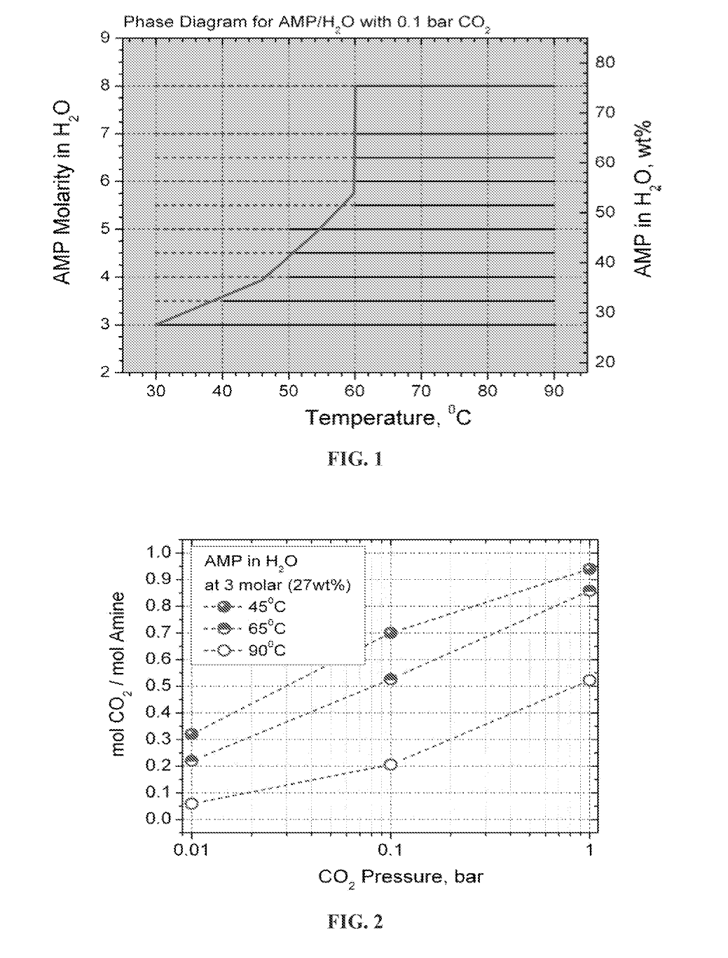

FIG. 1 shows a phase diagram for a solution of 2-amino-2-methyl-1-propanol (AMP) at a constant gas phase CO₂ partial pressure of ˜0.1 bar (˜10 kPa), where the horizontal axis is temperature and the vertical axis is the concentration of AMP in aqueous solution. The dotted lines in the left portion of the figure represent portions of phase space where a solid phase is present at equilibrium (such as a precipitate slurry), while the solid lines to the right represent a solution only. About 0.1 bar (about 10 kPa) was selected in FIG. 1 as being a representative partial pressure of CO₂ that may be encountered when a gas stream containing CO₂ is contacted with an amine solution for carbon capture. Based on FIG. 1, AMP can be an example of an amine having a solid-liquid phase transition at temperatures between ˜30° C. and ˜60° C. for some solutions of reasonable amine concentration for CO₂ capture and release processes, such as solutions with an AMP concentration of ˜3.5M to ˜6.0M. The temperature range of about 30° C. to about 60° C. can be beneficial, as no cooling below ambient temperature would be required and, for systems based on aqueous solutions, no boiling of the solvent would be required. Additionally AMP solutions with a concentration of ˜3.5M to ˜6.0M can have a viscosity low enough to provide good flow properties. If it is desired to perform the capture process at a temperature above ˜60° C., still higher AMP concentrations can be suitable.

As shown in FIG. 1, increasing the temperature of an amine solution such as AMP) can generally decrease the concentration of the amine that can be retained in solution without forming an equilibrium solid phase, such as a solid phase that results in formation of a slurry. Thus, one way of inducing precipitation in an amine solution loaded with CO₂ can be to reduce the temperature of the solution. An additional or alternative way to induce precipitation can be to increase the concentration of amines in the solution (and/or amine-CO₂ reaction product), e.g., while maintaining a relatively constant temperature.

FIG. 2 provides another type of analysis graph for understanding the behavior of hindered amines in solution in relation to the partial pressure of available CO₂. Instead of focusing on the solubility of amine-CO₂ reaction products, the plot in FIG. 2 shows the vapor-liquid equilibria between dissolved CO₂ (liquid) and gas phase CO₂ (vapor) for an aqueous amine solution where AMP is the amine. In FIG. 2, the horizontal axis corresponds to the partial pressure of CO₂ in the gas phase while the vertical axis represents the ratio of moles of CO₂ per mole of amine for a solution. The lines shown in FIG. 2 represent constant temperature lines.

It is noted that the equilibrium values in FIG. 2 appear to be dominated by the contribution of the amine to the amount of CO₂ sorption. The equilibrium concentration of CO₂ in water at around 25° C. and 100 kPa of CO₂ partial pressure appeared to be about 0.03 M. This value can be smaller at higher temperatures. As shown in FIG. 1, the equilibrium concentration for CO₂ in an ˜3M solution of AMP at around 45° C. and ˜10 kPa partial pressure can be greater than 3M, which can be approximately 2-3 orders of magnitude greater than the amount of equilibrium sorption due to water. Thus, the amount of CO₂ sorbed by an aqueous amine-containing stream can appear to be dominated by the amount of CO₂ sorbed by the amine, with the water itself contributing a negligible amount of capacity, (It is noted that the aqueous environment does appear to facilitate capture of CO₂ by the amines, as the aqueous environment allows formation of bicarbonate.)

FIG. 2 shows how modifying the temperature can impact the amount of CO₂ sorbed in an aqueous amine solution. For typical gases, it is known that the solubility of a gas in aqueous solution typically decreases as the temperature increases. In other words, the partial pressure for a vapor phase gas required to maintain a constant amount of dissolved gas in a solution can typically increase as the temperature increases. Addition of amine compounds can modify this equilibrium, e.g., by allowing additional dissolved CO₂ to remain in solution in the form of an amine salt (such as a carbamate, bicarbonate, or carbonate salt). However, as shown in FIG. 2, sorption by amines does not necessarily modify the basic trend that increased temperatures can lead to reduced concentrations in solution of dissolved gases.

For a conventional system where a solution phase (as opposed to a slurry) is maintained throughout a CO₂ capture and release (or sorption and desorption) cycle, a plot similar to FIG. 2 can be used to determine the potential working capacity of an amine solution. For example, CO₂ can be captured at conditions such as ˜0.1 bar (˜10 kPa) of CO₂ partial pressure at ˜45° C. as the solution exits the capture stage. These conditions can roughly correspond to capture of CO₂ from a stream with roughly a 10% CO₂ content, such as a flue gas. The solution rich in CO₂ can then be passed into a regeneration or release stage and heated to a release temperature, such as 90° C. (or possibly a temperature greater than the boiling point of the solvent order to release as much of the CO₂ as possible. The difference between the CO₂ in solution at the capture temperature and the CO₂ that remains in solution under the release conditions can represent the working capacity. If the CO₂ is released in a vessel with an increased partial pressure of CO₂, such as ˜1 bar (˜100 kPa), the potential working capacity of the solution can correspond to the difference between the data point at ˜45° C./˜0.1 bar (˜10 kPa) and the data point at ˜90° C./˜1.0 bar (˜100 kPa).

The working capacity for a CO₂ capture and release system involving precipitation to form a slurry can be markedly different from the working capacity for a pure solution based system. During capture, a vapor-liquid equilibria plot such as FIG. 2 can be used to determine the amount of CO₂ that can be captured without causing precipitation.

After the solution exits the capture stage, precipitation can then be induced to form a slurry of precipitated amine-CO₂ reaction products. At this point, the equilibria considerations can change in two ways. First, a second equilibrium can become important in the form of the solid-liquid equilibrium for the amine-CO₂ reaction products. The solid-liquid equilibrium can dictate how much of the amine-CO₂ reaction products precipitate out of solution. Second, due to the precipitation of the amine-CO₂ reaction products, the overall amine concentration in the solution can typically decrease. The vapor-liquid equilibria shown in FIG. 2 are based on an assumption of constant amine concentration in solution. As amine is removed from the solution in the form of a precipitate, the concentration of amine can be reduced, resulting in a corresponding decrease in the capacity of the solution to sorb CO₂. The correlation between reduced amine concentration and decrease in solution capacity may not be exactly linear, but, unless nearly complete removal of amine occurs due to precipitation, the correlation can be approximated as linear for purposes of this discussion.

In some embodiments, when the amine-CO₂ product(s) is(are) precipitated from solution, on the order of 50 wt % of the amine in solution can be precipitated as part of the reaction product. The exact amount can depend on a variety of factors, such as the amount of sorbed CO², the conditions used to cause precipitation, or a variety of other factors. For example, the initial amine concentration, the extent of CO₂ sorption or loading, the temperature, and the pressure can all influence whether all of the amine-CO₂ products in solution will precipitate, or whether only the portions of the amine-CO₂ products above the solubility limit will precipitate. Thus, on the order of ˜50 wt % can represent precipitation amounts ranging from about 20 wt % to about 80 wt % (or more). Since the amine trapped in the precipitate generally does not contribute to the vapor-liquid equilibria, the percentage of the amine trapped in the precipitate can cause a corresponding percentage decrease in the amount of CO₂ that can be sorbed at equilibrium. Thus, precipitation of the amine can result in a decrease of CO₂ sorption capacity also on the order of ˜50 wt %, such as between about 20 wt % and about 80 wt %. It is noted that, if colder temperatures are used to cause precipitation, the colder temperature can result in an increased equilibrium sorption value for CO₂ at a given amine concentration. However, if the temperature reduction is sufficiently small, for example less than about 30° C., the reduction in sorption capacity due to loss of amine in solution due to participation can usually more than overcome any increase in sorption capacity due to reduced temperature.

After precipitation, the precipitated solids can be separated from a majority of the solvent. This separation can effectively “lock in” the reduced CO₂ content in the majority of the solvent, by preventing the amines and/or CO₂ in the precipitate from rejoining the majority of the solvent. As a result, at least a portion of the working capacity can be based on the difference in sorbed CO₂ between the capture stage and the separated majority of solvent.

The remaining part of the working capacity can be determined based on the amount of CO₂ that remains sorbed in the amine solution after regeneration or release of CO₂. Separation of the precipitate can result in a slurry with an increased solids concentration. This slurry with increased solids concentration can then be passed into one or more regeneration stages. In the regeneration stage(s), the slurry can be exposed to reduced pressures, increased temperatures, stripping gases, or a combination thereof. After release of the CO₂, an aqueous amine solution with an increased amine content can remain behind. Any CO₂ present in the concentrated amine solution can also be recycled, and therefore can also help to define the potential working capacity for the CO₂ capture and release system.

### Solvent

The concentration of the amine in aqueous solution may be adjusted, e.g., to maintain the desired viscosity as needed, particularly for the rich solution containing the sorbed CO₂. In some preferred embodiments, the solvent can be water. Alternatively, a beneficial effect may be obtained by the use of a co-solvent with water, such as a polar, aprotic co-solvent. A polar co-solvent with the water may result in enhanced solvation of the reaction products, as compared to water alone or water with a co-solvent of lower polarity. For a solvent that precipitates at a relatively low concentration under desired capture conditions (such as AMP), addition of a polar solvent could allow for higher AMP concentrations at temperatures near 30° C., which could increase the working capacity by allowing for greater CO₂ sorption prior to precipitation. A polar solvent can additionally or alternatively increase the sorption of CO₂ by amines in solution, thereby facilitating increased loading/capacity of the sorbent. Purely non-aqueous polar solvents would be expected to be less corrosive, enabling the use of cheaper metallurgies, e.g., carbon steel, with reduced concern about corrosion, e.g., at higher loadings. Additionally or alternately, a non-ionic co-solvent can decrease the solubility of the ionic reaction products (i.e., bicarbonates and carbamates) generated during CO₂ sorption by an amine.

Preferred co-solvents can advantageously have a relatively high boiling point, e.g., at least about 65° C., preferably about 70° C. or higher, in order to enable reduced solvent losses in the process. Furthermore, higher boiling points can be desirable in some embodiments, depending on the regeneration conditions to be used. Use of higher boiling point solvents can conserve valuable energy that would otherwise be consumed in vaporization of the solvent.

Hindered amine systems can preferably be used in aqueous solution but may additionally or alternately be admixed with polar organic (co-)solvents. Suitable (co-)solvents can include, but are not limited to, lower alkanols with boiling points above 100° C.; ketones such as methyl ethyl ketone (MEK), methyl butyl ketone (MBK), methyl isobutyl ketone (MIBK), and the like; dimethylsulfoxide (DMSO); N-methylpyrrolidone (NMP); N,N-dimethylformamide (DMF); N,N-dimethylacetamide (DMAc); sulfolane (tetramethylene sulfone); hexamethylphosphoramide (HMPA); tetrahydrofuran (THF); acetonitrile; propylene carbonate; dimethyl ethers of ethylene and/or propylene glycols; esters such as ethyl acetate and/or amyl acetate; halocarbons such as 1,2-dichlororobenzene (ODCB); and combinations thereof.

Once the liquid sorbent medium has been formulated with hindered amine and the (co-)solvent/medium, optionally with ingredients such as antioxidants, corrosion inhibitors, and the like, it can be employed, for example, in a liquid process cyclic sorption unit, as described herein.

### Process Configuration

The initial CO₂ capture process can be carried out by contacting a CO₂-containing gas mixture and a solution of the amine sorbent in a capture or sorption zone in a reaction system. One example of a suitable structure for the sorption stage or zone can include or be a column or tower contactor. In the sorption zone, the incoming gas stream can normally be passed in a tower countercurrent to a descending stream of liquid sorbent solution at a relatively low temperature. The temperature can be from about 20° C. to about 80° C., such as at least about 25° C., about 45° C. or less, and/or about 40° C. or less. Optionally but preferably, the concentration of the amine (or amines) in the amine solution can be relatively close to the concentration for precipitation of amine-CO₂ reaction products at the temperature and pressure in the capture stage or zone. For example, the amine concentration can be selected so that, at the CO₂ partial pressure in the capture zone, the capture temperature can be less than about 20° C. greater than the temperature at which precipitation occurs, e.g., less than about 15° C. greater than the precipitation temperature. The CO₂ partial pressure in the capture zone can be related to the concentration of CO₂ in the gas phase stream input to the capture zone.

More generally, the stability of the CO₂/amine species can generally decrease with increasing temperature, so that sorption of the CO₂ can be favored by lower temperatures, but, with operation with flue gas, the temperature can typically be higher, unless the incoming gas stream is initially cooled. With natural gas streams, the temperature can often be lower, particularly if the gas has been passed through an expansion before entering the scrubbing unit. The sorption temperature can typically be at least about 10° C. (e.g., at least about 15° C., at least about 20° C., at least about 25° C., at least about 30° C., at least about 35° C., at least about 40° C., at least about 45° C., at least about 50° C., at least about 55° C., at least about 60° C., at least about 65° C., at least about 70° C., at least about 75° C., or at least about 80° C.) and/or at most about 90° C. (e.g., at most about 85° C., at most about 80° C., at most about 75° C., at most about 70° C., at most about 65° C., at most about 60° C., at most about 55° C., at most about 50° C., at most about 45° C., or at most about 40° C.). Depending on the embodiment, the temperature during a capture or sorption stage can be related to the concentration of the amine being used for capture, so that the amine-CO₂ reaction products can remain in solution during the capture stage while still allowing for precipitation with a modest change in temperature (or another condition). Temperatures below about 50° C. are likely to be favored for optimal sorption, if capable of attainment at relatively low incremental cost and/or if the incoming gas stream is already at such a temperature; these lower sorption temperatures can be routinely obtainable using a variety of well-known gas stream cooling methods, such as direct contact of a CO₂-containing gas stream with a chilled water spray or an air cooler.

After the capture zone, the CO₂-rich amine solution can be passed into a precipitation stage. Any convenient method can be used for causing precipitation of amine-CO₂ reaction products in the precipitation zone. One option for causing precipitation can be to cool the rich amine solution to a sufficiently cold temperature to cause precipitation. Depending on the exit temperature of the rich solution from the capture zone, the cooling can be performed using a chiller unit, a heat exchanger, or another convenient method for cooling a liquid flow. It is noted that the method for cooling the rich amine solution should also be compatible with the presence of the solid particles generated by precipitation. As an example, an ˜4M solution of AMP at a CO₂ partial pressure of about 0.1 bar (about 10 kPa) can be at equilibrium at a temperature of about 50° C. By contrast, precipitation will occur if the solution is chilled to a temperature below about 40° C. or lower, such as about 30° C. or lower. Optionally, formation of a precipitate can be further facilitated by addition of seed crystals during the precipitation stage, such as addition of seed crystals composed of the corresponding amine-CO₂ salt.

Another way to induce precipitation can be to increase the CO₂ loading (partial pressure) for the solution. In this option, the rich amine solution can be passed into a stage with a sufficiently higher partial pressure of CO₂ so that precipitation can occur. One source for the CO₂ used to oversaturate the solution can be to recycle at least a portion of the CO₂ generated during the release stage. Optionally, the cooling and oversaturation methods can be used together in a single stage for causing precipitation.

Still another way to cause precipitation can be to increase the amine concentration, such as by removing water from the solution. This can be accomplished using a membrane separation process, such as a reverse osmosis membrane process, a vibrating membrane process, a pervaporation membrane process, a process using a molecular sieve separator, or the like, or a combination thereof. The molecular sieves could then be regenerated using hot flue gas or air going into a boiler/furnace/turbine.

Yet another option to induce phase separation with a traditional absorber system could be to pump the rich amine solution through a bed of solid particles in order to pull out the bicarbonate species (i.e., the amine-CO₂ reaction products). These solids could then be regenerated separately.

After precipitation, the amine-CO₂ precipitate slurry can be separated, e.g., to remove at least a portion of the water from the precipitate slurry. This can result in generation of an amine solution lean in CO₂ content and a concentrated precipitate slurry. The separation to form a lean amine solution and concentrated precipitate slurry can be performed in any convenient manner. One option can be to use a cyclone separator or another type of density based separator. Another option can be to perform a membrane type separation with a membrane pore size sufficiently smaller than the average particle size of the precipitate particles. The lean amine solution can be recycled for use in additional CO₂ capture. The concentrated precipitate slurry can be passed into one or more stages for CO₂ release.

During the CO₂ release or regeneration stage(s), the concentrated precipitate slurry can be exposed to increased temperatures and/or modified temperatures in order to separate the CO₂ from the amine. Depending on the embodiment, one or more regeneration stages or zones may be involved in regeneration. For example, a regeneration tower can be used for separation of the CO₂ in the precipitated amine-CO₂ solids by a change in conditions under which desorption is favored, typically by change in temperature (usually an increase), pressure, or a combination thereof. In a preferred embodiment, an intermediate heat exchanger upstream of the regenerator tower may be used to flash off CO₂ from the precipitated product and/or from remaining dissolved amine-CO₂ product at a lower temperature (but higher than the sorber temperature), thereby reducing the load on the regenerator. After either the flash separation and/or a regeneration tower, a higher temperature regeneration zone may be included to desorb any CO₂ that was sorbed in the form of carbamate. Such a higher temperature regeneration zone can include a regeneration temperature of at least about 100° C., such as at least 120° C. Gas stripping may be used to raise the temperature and/or decrease the partial pressure of the CO₂ to favor desorption. The regenerated amine solution (the lean stream) may then be recirculated to the sorption tower after cooling if necessary. The desorbed CO₂ from the regeneration zone may be compressed and/or liquefied for transport to a sub-surface storage (i.e., sequestration) or for utilization, e.g., for CO₂ Enhanced Oil or Gas Recovery or for use as a feedstock in chemical manufacture.

Desorption temperatures can be dependent on the selected system, e.g. amine and/or CO₂ concentration, and can typically be at least about 10° C. above, e.g., at least about 15° C. above or at least about 20° C. above, the temperature in the sorption zone. Preferably, due to the concentrated nature of the precipitate slurry, release of the captured CO₂ can often be performed at temperatures below the boiling point of water for another solvent), a release temperature of about 95° C. or less, about 75° C. or less, about 60° C. or less, or about 50° C. or less. One option can be thermal desorption, where a rich solution can be passed through a hot bath with a head space at controlled pressure (typically about ˜1.0 bar, or ˜100 kPa). Pressure control can be effected by removal of the desorbed gas at an appropriate rate. If multiple regeneration stages are present, each regeneration stage can have a different temperature, such as an increasing temperature in each successive regeneration stage.

A slip stream of the previously separated CO₂ may additionally or alternatively be used for stripping, although the concentration of residual CO₂ in the lean sorbent stream returning to the sorption tower may be higher, and compensation to lower the CO₂ partial pressure in the tower can be required to facilitate carbamate decomposition. The reduction in the CO₂ partial pressure from gas stripping can promote desorption of the gas, and, when this expedient is used, there may be no requirement for a significant pressure reduction, although the pressure may be reduced for optimal stripping, suitably to the levels used in pressure swing operation. Stripping with mixtures of an inert (non-reactive) gas and hot CO₂ may be effective. When carrying out the desorption by inert gas sparging and/or pressure swing operation, the temperature may be maintained at a value at or close to that used in the sorption step, although desorption can be favored by an increase in temperature from the sorption zone to the regeneration zone, either with or without stripping or a decrease in pressure. When stripping with previously separated CO₂, desorption of the CO₂ from the rich solution stream can be favored by heating the CO₂ stripping gas.

After release of CO₂, the lean amine solution from the physical slurry separation and the CO₂ release stage can be recycled for use in the CO₂ capture stage. If necessary, the temperature of the recycled amine solution can be adjusted prior to return to the capture stage.

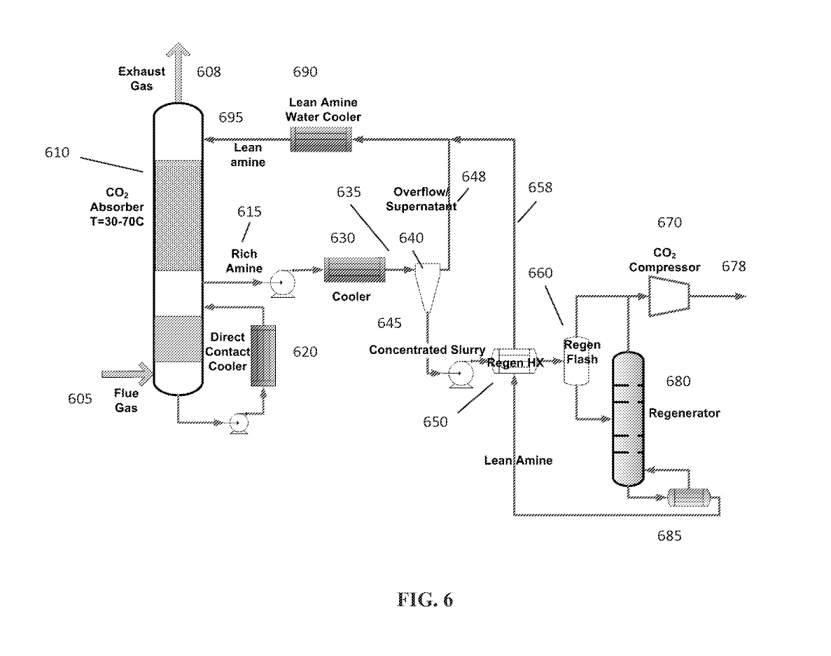

FIG. 6 shows an example of a reaction system suitable for performing CO₂ capture and release according to an embodiment of the invention. In FIG. 6, a flue gas 605 containing CO₂ can be passed into an absorber 610 for contact with an amine solution 695. The conditions in absorber 610 can be maintained at a temperature so that precipitated reaction products are not formed in the absorber. A direct contact cooler 620 can be used to cool the flue gas 605 prior to contacting the amine solution 695. The flue gas can then be contacted with the amine solution 695 to form a rich amine solution 615 enriched in CO₂. After optionally increasing the pressure of the solution, the enriched amine solution can be exposed to conditions that induce precipitation, such as cooling 630 the solution. This can result in precipitation of amine-CO₂ products to form a precipitate slurry 635. The precipitate slurry 635 can then be separated, such as by using one or more cyclone separators 640, to form a concentrated slurry 645 and an overflow stream 648. The overflow stream 648 can correspond to an amine-containing solution depleted in amine content. The concentrated slurry 645 can contain the majority, and/or substantially all, of the precipitate from the precipitate slurry 635. The concentrated slurry can then be passed through a slurry/slurry heat exchanger 650 to increase the temperature of the concentrated slurry prior to regeneration. A portion of the CO₂ can be removed from the slurry in a flash separator 660 and passed to a compressor 670 to form an output CO₂ stream 678. The remaining slurry can then be passed into regeneration tower 680 for release of additional CO₂ to regenerate the amine solution portion of the concentrated slurry. The CO₂ released in regeneration tower 680 can also be passed to compressor 670 to form output CO₂ stream 678. The remaining amine solution portion 685 can be passed through slurry/slurry heat exchanger 650 to cool the remaining amine solution portion 685. The cooled remaining amine solution 685 and overflow stream 648 can be combined and further cooled 690 to form amine stream 695.

### Other Options for Causing Precipitation

Still another option using the phase separation behavior of the amine products can be to form a slurry in the capture zone, such as by bubbling CO₂ up through a vessel filled with liquid amine. The key economic consideration for this option can be the pressure required to overcome the static head of the liquid in the vessel. About 1 psig (about 7 kPag) can be equivalent to ˜2.3 feet of water. For a pressure drop of ˜2 psig (˜15 kPag) from a single blower fan, the amine height would be limited to about 4 feet. This can likely be insufficient to achieve a ˜90% capture rate. Additional blower fans could be installed to boost the pressure. It is possible in this liquid continuous reactor, that the distributor/DCC could be eliminated, thus offsetting a portion of the additional costs of flue gas pressure. In this type of arrangement, a tower design can be selected to be compatible with handling a slurry flow of precipitate particles.

Yet another option to use the phase separation behavior can be to use a spray tower design. This type of option can involve a gas continuous arrangement with liquid droplets of amine being sprayed into the CO₂-containing gas, so that pressure drop can be reduced and/or minimized. The tower can either be a traditional vertical spray tower, or a horizontal “tower”, which may be advantageous if the vertical tower would need to be prohibitively tall.

### Promotion of Amines

The sterically hindered amines can be used as the CO₂ capture agents without the necessity of a promoter to facilitate the reaction (e.g., to increase the reaction rate) in most cases. Thus, in certain embodiments, the solution can consist essentially of the sterically hindered amine sorbent with solvent and additives (e.g., anti-foam additives, antioxidants, etc.). In such certain embodiments, the solution can specifically comprise no intentionally added promoters, particularly no intentionally added nitrogen-containing promoters. Alternatively, in some embodiments a promoter, such as a heterocyclic promoter and/or a piperazinyl type promoter, may be used in systems where the reaction rate is considered insufficient. More generally, combinations of the sterically hindered amines may be used or combinations with other amines such as those conventionally used in acid gas separation systems (e.g., MEA and/or DEA), and the use of an intentionally added promoter (e.g., a piperazinyl promoter) in the mixed system as described above, is not necessarily excluded, particularly if the reaction rate is found to be unacceptably slow.

### Alternative Solvent Systems

In addition to sterically hindered amines in solution, such as sterically hindered amines in aqueous solution, other types of systems with non-aqueous solutions can also be suitable for use in forming precipitate slurries. For example, non-polar amines (or amine mixtures) in a nonpolar non-aqueous solution can have a reasonable level of solubility prior to reaction with CO₂. After reaction with CO₂, however, the initially nonpolar amines can form highly polar carbamate species (R—N—COO⁻ . . . ⁺H—N—R), which may not be soluble in a nonpolar solvent, even at low concentration. When such polar carbamate species are formed, the carbamates can precipitate. This mechanism can be operative over a broad range of temperatures and amine concentrations. In polar non-aqueous solvents (e.g., sulfolane), reaction products might still be soluble at relatively low concentrations, and precipitation of reaction products can be achieved at higher amine concentrations.

In addition to carbamates having relatively low solubility in non-polar solvents, for both aqueous and non-aqueous amine solutions, carbamate species can be formed first after an intermediate z.witterion formation. Due to the multifunctionality of polyamine molecules (those with two or more amines per molecule), CO₂ may form intramolecular (within one polyamine, using two amine functionalities from a single molecule) and/or intermolecular (between two polyamines, i.e., using amine functionalities from different molecules) carbamates. In the latter case, growing large clusters of molecules may be expected, due to multiple intermolecular carbamate formations per single polyamine molecule. At a certain critical weight, these clusters may precipitate from solution. Thus, When stable carbamates are formed in at least the above scenarios, two separate (and possibly complementary) mechanisms can potentially be available for forming a precipitate slurry.

### Additional Embodiments

Additionally or alternatively, the present invention can include one or more of the following embodiments.

Embodiment 1. A method for separating carbon dioxide from a gas stream, comprising: contacting a gas stream containing CO₂ in a sorption zone with a sorption solution comprising an amine, the sorption solution having a total amine concentration of at least about 2.0 M, and optionally an additional promoter amino at a temperature of at least 10° C. to sorb at least a portion of the CO₂ into the sorption solution and form a rich stream of the sorbed CO₂ in the sorption solution comprising amine-CO₂ reaction products dissolved in the solution; passing the rich stream from the sorption zone to a second zone and precipitating at least a portion of the amine-CO₂ reaction products to form a precipitate slurry; separating the precipitate slurry to form a portion enriched in precipitate solids and a first recycle stream, the first recycle stream comprising a majority of the solvent from the precipitate slurry; and passing the portion enriched in precipitate solids to one or more regeneration zones and desorbing the sorbed CO₂ as gas to form a second recycle stream, the second recycle portion containing a lower concentration of CO₂ than the rich stream and containing an increased concentration of amine relative to the rich stream, wherein the sorption solution comprises at least a portion of the first recycle stream and at least a portion of the second recycle stream.

Embodiment 2. The method of embodiment 1, wherein the total amine concentration in the sorption solution is at least about 2.5M, e.g., from about 5.0 M to about 8.0M.

Embodiment 3. The method of embodiment 1 or embodiment 2, wherein the carbon dioxide loading in the rich stream is at least 0.4 mol CO₂ per mol of amine

Embodiment 4. The method of any one of the previous embodiments, wherein the amine comprises a sterically hindered amine, e.g., comprising or being AMP and/or MAMP, such as comprising or being AMP, the sterically hindered amine concentration in the amine solution thus preferably being from about 2.5M to about 7.0M.

Embodiment 5. The method of any one of the previous embodiments, wherein the carbon dioxide is contacted with the amine solution in the sorption zone at a temperature of about 25° C. to about 45° C.

Embodiment 6. The method of any one of the previous embodiments, :Wherein the carbon dioxide is contacted with the amine solution in the sorption zone at a carbon dioxide partial pressure of at least 0.025 bar (2.5 kPa).

Embodiment 7. The method of any one of the previous embodiments, wherein the viscosity of the rich stream is about 10 cP or less, e.g., about S cP or less, about 7 cP or less, or about 5 cP or less.

Embodiment 8, The method of any one of the previous embodiments, wherein the sorbed carbon dioxide is desorbed from the rich stream in the one or more regeneration zones at a temperature higher than the temperature of the sorption zone,

Embodiment 9. The method of any one of the previous embodiments, wherein at least a portion of the sorbed carbon dioxide is desorbed from the rich amine stream in the one or more regeneration zones at a temperature of 95° C. or less, at a temperature of at least about 100° C. (such as at least about 120° C.), or a combination thereof.

Embodiment 10. The method of any one of the previous embodiments, wherein the at least one regeneration zone comprises a flash desorption regeneration zone.

Embodiment 11. The method of any one of the previous embodiments, wherein at least 80 wt % of the precipitate solids comprise a bicarbonate salt.

Embodiment 12. The method of any one of the previous embodiments, wherein the CO₂-containing gas stream is contacted with the sorption solution at a temperature greater than a temperature in the second zone by 20° C. or less.

Embodiment 13. The method of any one of the previous embodiments, wherein the sorption solution comprises an aqueous sorption solution, a non-aqueous sorption solution, or a combination thereof.

Embodiment 14. The method of any one of the previous embodiments, wherein the non-aqueous sorption solution comprises an amine containing multiple amine groups, the precipitate solids comprising carbamates formed between an amine group from a first compound and an amine group from a second compound.

Embodiment 15. A method for separating carbon dioxide from a gas stream, comprising: contacting a gas stream containing CO₂ in a sorption zone with a sorption solution comprising a sterically hindered amine, the sorption solution having a total amine concentration of at least about 2.5 M, at a temperature of at least 10° C. to sorb at least a portion of the CO₂ into the sorption solution and form a rich stream of the sorbed CO₂ in the sorption solution comprising amine-CO₂ reaction products dissolved in the solution; passing the rich stream from the sorption zone to a second zone and precipitating at least a portion of the amine-CO₂ reaction products to form a precipitate slurry; separating the precipitate slurry to form a portion enriched in precipitate solids and a first recycle stream, the first recycle stream comprising a majority of the solvent from the precipitate slurry, at least 80 wt % of the precipitate solids comprising a bicarbonate salt; and passing the portion enriched in precipitate solids to one or more regeneration zones and desorbing the sorbed CO₂ as gas to form a second recycle stream, the second recycle portion containing a lower concentration of CO₂ than the rich stream and containing an increased concentration of sterically hindered amine relative to the rich stream, wherein the sorption solution comprises at least a portion of the first recycle stream and at least a portion of the second recycle stream.

The following provide examples of forming precipitate slurries for both sterically hindered amines as well as amines in non-polar solution,

### EXAMPLES

### Example 1

### 70 wt % TMG in D₂O

¹³C NMR was used to characterize uptake of CO₂ by an amine in a deuterium oxide solution. An ˜70 wt % solution of 1,1,3,3-tetramethylguanidine (TMG) was prepared in D₂O in an about 10 mm NMR tube fitted with a plastic cap and capillary dip tube. The NMR tube was placed inside an ˜10 mm wide-bore Bruker Advance 400 MHz NMR spectrometer with a BBO probe. After initial characterization, the TMG solution was heated to about 90° C. and CO₂-containing gas (about 10% CO₂/90% N₂ by volume) was bubbled (about 10 cm³/min, measured by a Brooks 5896 flow controller) through the solution for approximately 6 hours until no further CO₂ uptake was observed by NMR. Although 1,1,3,3-tetramethylguanidine includes multiple amine groups, they are each believed to qualify as a sterically hindered amine, based on the number of protons on an alpha carbon atom.

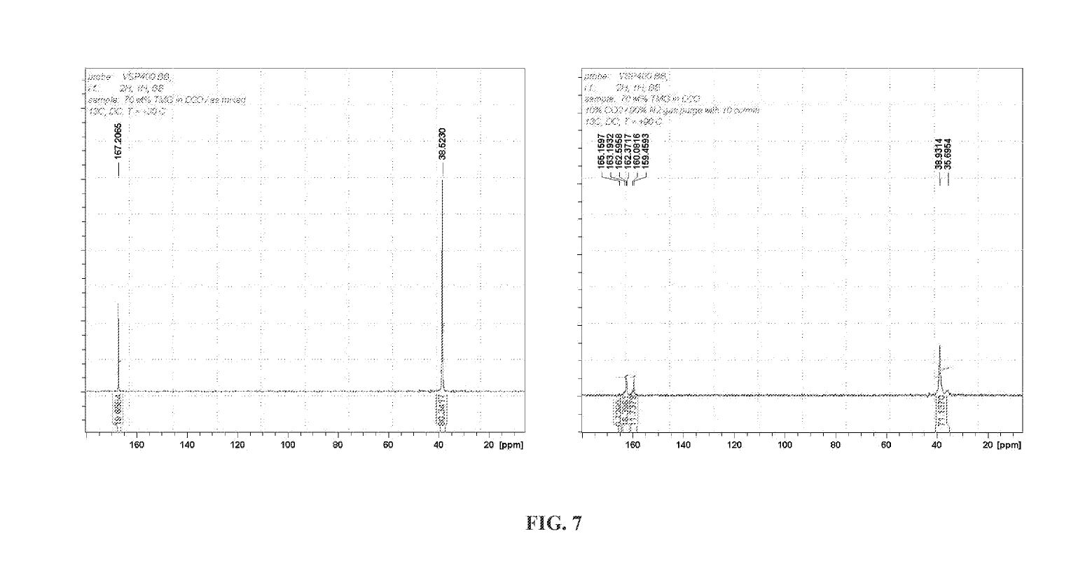

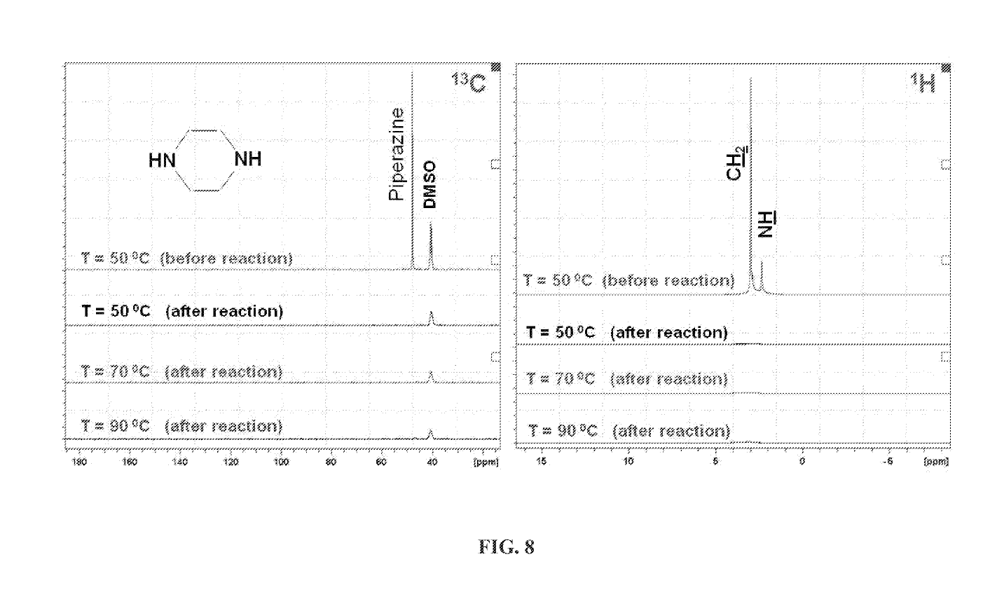

As shown in FIG. 7, the initial NMR spectrum of the starting material appeared to change upon CO₂ addition, indicating the formation of bicarbonate product (>C═O resonance at ˜159.4 ppm). The protonation of the guanidine to guanidinium can be confirmed by the shift of the >C═N resonance at ˜167.2 ppm upfield to ˜162.3 ppm. Detailed analysis of initial and reacted TMG signals appeared to show significant loss of TMG liquid phase signal —only ˜43.9 mol % of TMG was observed to remain in the solution after reaction with CO₂/N₂ mixture. Another ˜56.1 mol % of TMG molecules appeared to precipitate from solution (and thus did not appear to result in a liquid signal) after reaction with CO₂ into a white slurry, which was confirmed visually. Based on integration of the liquid phase products (FIG. 7, peak at ˜159.4 ppm versus the >C═N peak of guanidine at ˜162.6 ppm), ˜31.3 mol % of guanidine molecules (or ˜71,4 mol % of the TMG remaining in the liquid phase) appeared to form bicarbonate in solution. Only ˜12.6 mol % of the TMG appeared not to react to form soluble or insoluble products after the CO₂ purge. (˜31.3 mol % of TMG molecules appeared to form bicarbonate in liquid phase; ˜56.1 mol % appeared to precipitate from solution, presumably forming bicarbonate and losing solubility.) Precipitation of TMG-bicarbonate was confirmed by NMR on a solution that had been diluted with D₂O until the precipitate was brought into the liquid phase again. At about 60 wt % concentration of D₂O in this solution (or ˜40 wt % of TMG), no slurry was observed, and the solution appeared completely transparent, According to a liquid NMR experiment on this sample (not shown here), about 100% of the TMG molecules appeared to react with CO₂. About 82% of the TMG appeared to form a bicarbonate, while the other ˜18% appeared to form a carbamate, resulting in an initial loading of ˜0.91 CO₂ per TMG. This appeared to confirm that the product in the initially precipitated phase was mostly TMG-bicarbonate. Thus, little carbamate was produced as a long lifetime product, as expected for a sterically hindered amine. This example shows that a significant amount of TMG can precipitate from ˜70 wt % aqueous solution at 90° C. after reaction with CO₂. Higher TMG concentrations can lead to precipitation at ˜90° C. as well. At ambient temperatures, TMG concentrations above about 40 wt % were observed to lead to loss of solubility of the TMG-bicarbonate.

### Example 2

### Piperazine in DMSO-d6

An ˜10 wt % solution of piperazine in d6-DMSO was prepared in the manner described in Example 1. This concentration was approximately the highest allowable to keep the relatively nonpolar piperazine molecules in solution with the relatively polar DMSO. After treatment with CO₂ at about 50° C. for about 30 minutes, a liquid signal from piperazine and its products was not detected by both ¹H and ¹³C NMR (FIG. 8). Formation of a white precipitate was confirmed visually. Without being bound by theory, it is believed that this was due to formation of intermolecular carbamates on piperazine after reaction with CO₂, leading to loss of piperazine solubility in this polar, non-aqueous solvent. Precipitates were observed to be relatively stable at ˜70° C. and ˜90° C., as indicated in FIG. 8 (no decomposition back to liquid species detected).

### Example 3

### Piperazine/TMG in DMSO-d6

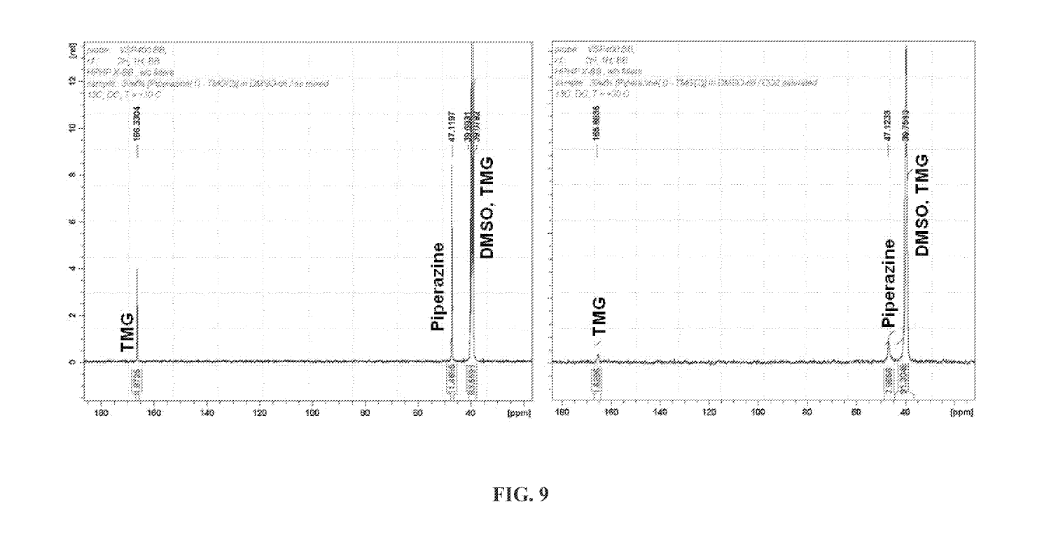

An ˜30 wt % solution of an ˜1:2M mixture of piperazine and tetramethylguanidine (TMG) was prepared in d₆-DMSO in an ˜10 mm NMR tube fitted with a plastic cap and capillary dip tube. ¹³C and ¹H spectra were taken to determine and/or confirm the structure and molar ratios. Such solution was prepared to confirm mixed carbamate formation between TMG and piperazine molecules. CO₂ (˜1 atm, ˜99.98% purity) was bubbled through the room temperature solution. ¹³C and ¹H spectra recorded during the experiment appeared to show loss of liquid signal from both piperazine and TMG. Detailed analysis of initial and completely reacted solutions (FIG. 9) appeared to show significant loss of TMG and piperazine liquid phase signal after reaction with CO₂. Only ˜19.2 mol % of TMG and ˜36.0 mol % of piperazine molecules appeared to remain in the solution after reaction with CO₂. About 80.8 mol % of TMG and about 64.0 mol % of piperazine appeared to react with CO₂, appearing to precipitate from solution to form a white powder, which was confirmed visually. It is noted that TMG alone does not generally react with CO₂ in non-aqueous solution. Based on the observation of loss of liquid-phase TMG in the current experiment, and without being bound by theory, it is believed that mixed carbamate formation can occur between either of the piperazine nitrogens and the strongest base present, the N═C nitrogen of TMG, which appeared to precipitate from DMSO solution. Precipitates were observed to be stable at 100° C. as well, with little or no decomposition back to liquid species detected.

### Example 4

### PEI in d6-DMSO

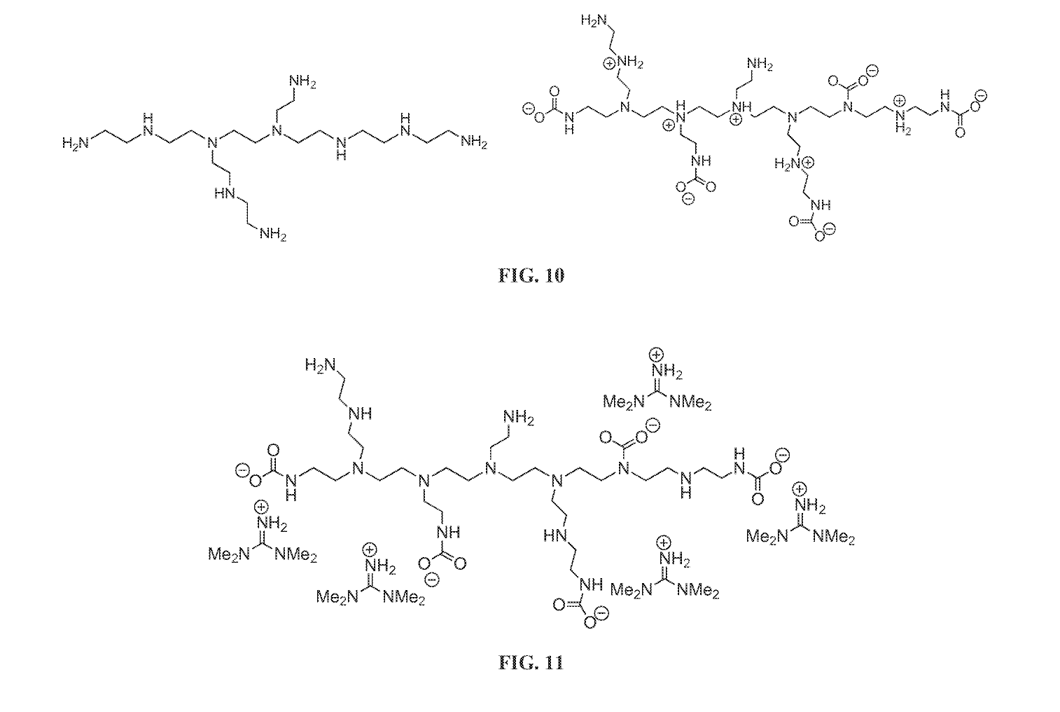

Polyamine molecules with relatively high amine density and lower volatility can be considered as a potential way to improve CO₂ absorption capacity and CO₂ capture process schemes. One such class of polyamines that has received a great deal of attention includes polymers of ethylenimine, —(CH₂CH₂NH)ₓ—. FIG. 10 shows an approximate structure of a commonly used polyamine, branched polyethylenimine (PEI), indicating a distribution of primary, secondary, and tertiary amine sites. At relatively high levels of CO₂ uptake, the relatively high amine density of polyethylenimine can generate a relatively high charge density (FIG. 10). In nonpolar solvents, the strong electrostatic attractions and repulsions between these highly charged polymer chains can result in agglomeration, leading to higher viscosity and/or phase separation. It was experimentally confirmed (not shown here) that, even at a low concentration of PEI molecules (˜10 wt %) in non-aqueous solvents (DMSO-d6 or CDCl₃), PEI molecules appeared to form a viscous gel, which was observed to precipitate after several minutes of CO₂ flow (˜5.5 cm³/min) through the solution at room temperature (˜20-2.5° C.). ¹³C and ¹H NMR spectra (not shown here) did not appear to indicate liquid signal from the sample, except for that attributable to the solvent, confirming complete phase transition for PEI/CO₂ reaction products. In contrast to Examples 1-3, in which compounds appeared to form isolated precipitates or slurries, the reaction product of polyamines in non-aqueous solvents can form a very viscous gel, which might be difficult to handle during a regeneration stage. Similar gel formation was experimentally observed with several other multi-amine molecules in non-aqueous solution.

### Example 5

### PEI in d6-DMSO

It has been determined that intermolecular interactions (e.g., gel formation) can be minimized/prevented, while still keeping the relatively high CO₂ sorption properties of polyamine molecules. Amine-based reacting solvents can be used to form local mixed carbamates between a polyamine and a solvent. This mechanism can still utilize a high level of amine sites (absorbing more CO₂) without incurring a viscosity increase. However, precipitation can be achieved even in this case by choosing a relatively nonpolar reactive solvent.

An ˜22 wt % solution of PEI in TMG was prepared in an ˜5 mm NMR tube. The nonpolar PEI molecules were observed to be relatively readily soluble in nonpolar TMG at ambient temperature (˜15-23° C.). After treatment with CO₂, a solid phase in the tube was observed, and a liquid phase PEI signal was not detected by NMR (not shown here). In contrast to Example 4, the solid phase appeared powder-like. Without being bound by theory, it is believed that the primary and secondary amities of PEI molecules reacted with CO₂ and TMG, forming the mixed carbamates schematically shown on FIG. 11. After reaction with CO₂ and TMG, the initially nonpolar PEI can comprise multiple highly polar mixed carbamates. Such a density of polar groups can reduce the solubility of the reacted PEI in nonpolar TMG solution and can cause precipitation of the CO₂ reaction products from solution. In order to confirm this mechanism, additional comparative experiments were performed with a polar co-solvent (DMSO-d6), which, in contrast to pure TMG solvent, was designed to help keep the polar reaction products in solution.

Although the present invention has been described in terms of specific embodiments, it need not necessarily be so limited. Suitable alterations/modifications for operation under specific conditions should be apparent to those skilled in the art. It is therefore intended that the following claims be interpreted as covering all such alterations/modifications as fall within the true spirit/scope of the invention.

What is claimed is:

1. A method for separating carbon dioxide from a gas stream, comprising:
contacting a gas stream containing CO₂ in a sorption zone with a sorption solution comprising an amine, the sorption solution having a total amine concentration of at least about 2.0 M, at a temperature of at least 10° C. to sorb at least a portion of the CO₂ into the sorption solution and form a rich stream of the sorbed in the sorption solution comprising one or more amine-CO₂ reaction products dissolved in the solution;
passing the rich stream from the sorption zone to a second zone and precipitating at least a portion of the amine-CO₂ reaction products to form a precipitate slurry;
separating the precipitate slurry to form a portion enriched in precipitate solids and a first recycle stream, the first recycle stream comprising a majority of the solvent from the precipitate slurry; and
passing the portion enriched in precipitate solids to one or more regeneration zones and desorbing the sorbed CO₂ as gas to form a second recycle stream, the second recycle portion containing a lower concentration of CO₂ than the rich stream and containing an increased concentration of amine relative to the rich stream,
wherein the sorption solution comprises at least a portion of the first recycle stream and at least a portion of the second recycle stream.

2. The method of claim 1, wherein the amine comprises at least one of a sterically hindered amine or a sterically hindered secondary amine.

3. The process according to claim 1, wherein the sterically hindered amine is AMP or MAMP, the sterically hindered amine concentration in the amine solution being from about 2.5M to about 7.0M.

4. The process according to claim 1, wherein the total amine concentration in the sorption solution is at least about 2.5M.

5. The process according to claim 1, wherein the total amine concentration in the sorption solution is from about 5.0 M to about 8.0 M.

6. The process according to claim 1, wherein the CO₂ loading in the rich stream is at least about 0.4 mol CO₂ per mol of amine.

7. The process according to claim 1, wherein the CO₂ is contacted with the amine solution in the sorption zone at a temperature of about 25° C. to about 45° C.

8. The process according to claim 1, wherein the CO₂ is contacted with the amine solution in the sorption zone at a CO₂ partial pressure of at least about 0.025 bar (about 2.5

9. The process according to claim 1, wherein the viscosity of the rich stream is about 10 cP or less.

10. The process according to claim 1, wherein the sorbed CO₂ is desorbed from the rich stream in the one or more regeneration zones at a temperature higher than the temperature of the sorption zone.

11. The process according to claim 10, wherein the sorbed CO₂ is desorbed from the rich amine stream in at least one regeneration zone at a temperature of 95° C. or less.

12. The process according to claim 10, wherein the sorbed CO₂ is desorbed from the rich amine stream in at least one regeneration zone at a temperature of at least about 100° C.

13. The process according to claim 1, wherein the at least one regeneration zone comprises a flash desorption regeneration zone.

14. The process according to claim 1, wherein at least 80 wt % of the precipitate solids comprise a bicarbonate salt.

15. The process according to claim 1, wherein the sorption solution further comprises a promoter amine.

16. The process according to claim 1, wherein the CO₂-containing gas stream is contacted with the sorption solution at a temperature greater than a temperature in the seem( zone by at most 20° C.

17. The process according to claim 1, wherein the sorption solution comprises an aqueous sorption solution, a non-aqueous sorption solution, or a combination thereof.

18. The method of claim 17, wherein the non-aqueous sorption solution comprises an amine compound containing multiple amine groups.

19. The method of claim 17, wherein the precipitate comprises carbamates formed between an amine group from a first compound and an amine group from a second compound.

20. A method for separating carbon dioxide from a gas stream, comprising:
contacting a gas stream containing CO₂ in a sorption zone with a sorption solution comprising a sterically hindered amine, the sorption solution having a total amine concentration of at least about 2.5 M, at a temperature of at least 10° C. to sorb at least a portion of the CO₂ into the sorption solution and form a rich stream of the sorbed CO₂ in the sorption solution comprising one or more amine-CO₂ reaction products dissolved in the solution;
passing the rich stream from the sorption zone to a second zone and precipitating at least a portion of the amine-CO₂ reaction products to form a precipitate slurry;
separating the precipitate slurry to form a portion enriched in precipitate solids and a first recycle stream, the first recycle stream comprising a majority of the solvent from the precipitate slurry, at least 80 wt % of the precipitate solids comprising a bicarbonate salt; and
passing the portion enriched in precipitate solids to one or more regeneration zones and desorbing the sorbed CO₂ as gas to form a second recycle stream, the second recycle portion containing a lower concentration of CO₂ than the rich stream and containing an increased concentration of sterically hindered amine relative to the rich stream,
wherein the sorption solution comprises at least a portion of the first recycle stream and at least a portion of the second recycle stream.
